(19) United States
(12) Patent Application Publication
(10) Pub. No.: US 2007/0046445 A1
(43) Pub. Date: Mar. 1, 2007

(54) Pneumatic pressure burglarproofing alarm

(76) Inventors: Yao Ying Zhang, Montreal (CA); Mikio Shimada, Nagoya City (JP)

Correspondence Address: TROXELL LAW OFFICE PLLC, SUITE 1404, 5205 LEESBURG PIKE, FALLS CHURCH, VA, 22041, US

(21) Appl. No.: 11/215,030

(22) Filed: Aug. 31, 2005

(51) Int. Cl. B60R 25/10

(52) U.S. Cl. 340/426.26

(57) ABSTRACT

It is, therefore, an object of the present invention to provide a burglarproofing alarm and particularly a pneumatic pressure burglarproofing alarm in which air pressure is detected to determine if an alarm should be issued. The burglarproofing alarm comprises a body case, a central control circuit, a sensor device and an alarm raising device disposed in the body case.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

The present invention pertains to a pneumatic pressure burglarproofing alarm, having a central control circuit, a sensor device and an alarm raising device communicatively connected to the central control circuit. The sensor device comprises a pneumatic transducer and an active human body infrared ray transducer. With the aid of the pneumatic transducer and active human body infrared ray transducer, the central control circuit capable of analyzing and determining an input signal therefrom may precisely issue an alarm when an exception occurs.

2. Background

To prevent home or car environments from burglar invasion, burglarproofing alarms are generally suggested to be installed. For example, infrared alarms are often adopted in the home environment to detect any invaders by emitting an infrared ray. However, the infrared ray emitting such infrared alarm only has a narrow coverage range and the burglar without difficulty may keep himself away from the coverage range and conduct criminal activity.

In addition, an audio burglarproofing alarm is generally adopted in a car environment and is separately disposed therein. Such audio burglarproofing alarm operates by detecting any exception occurring within a specific audio range. When an offender is making a criminal conduct, the sound accompanied therewith may cause the audio burglarproofing alarm, making a high decibel sound to let the car holder perceive the crime and intimidate the offender. However, such audio burglarproofing alarm also has a problem since it may not only detect sounds inside the car but also outside the car. As a result, an improper alarm is possible to be caused by the audio burglarproofing alarm and may not satisfy the user's demand.

3. Description of Prior Art

To resolve the problem encountered in the prior art, the present invention provides a novel burglarproofing alarm having a wider coverage range and a significantly improved alarm accuracy.

According to an aspect of the present invention, the alarm comprises a body case, a central control circuit, a sensor device and an alarm raising device disposed in the body case, the sensor device and alarm raising device being communicatively connected to the central control circuit and the sensor device comprising a pneumatic transducer and an active human body transducer.

According to another aspect of the present invention, the sensor device also comprises an ultrasonic transducer.

In addition, the pneumatic transducer comprises a piezoelectric element, with the piezoelectric element outputting an electric signal by detecting an air pressure variation.

In addition, the burglarproofing alarm comprises a plurality of secondary bodies each comprising a sensor device and a transmitter device transmitting a signal to the central control circuit. In each of the secondary bodies, the sensor device may be one or more of the pneumatic transducers, the active human body infrared ray transducer, an ultrasonic transducer, a magnetic transducer and an infrared ray transducer.

In addition, the burglarproofing alarm comprises a sound recording device and a visible doorbell system.

According to yet another aspect, the burglarproofing alarm has a remote control, the remote control having a buzzer and/or a vibration motor. The buzzer and/or vibration motor is activated concurrently when the alarm raising device is activated by the central control circuit. Preferably, the remote control comprises a display window, displaying a human body position detected by the active human body infrared ray transducer by the central control circuit.

### SUMMARY OF INVENTION

A pneumatic pressure burglarproofing alarm is disclosed, comprising a body case, a central control circuit, a sensor device and an alarm raising device disposed in the body case, the sensor device and alarm raising device being communicatively connected to the central control circuit and the sensor device comprising a pneumatic transducer and an active human body transducer. When an exception occurs, the alarm may issue an alarm in a precise manner.

### BRIEF DESCRIPTION OF THE DRAWINGS

FIG. 1 is a top view of a primary body of a burglarproofing alarm according to a first embodiment of the present invention, which is particularly for home use;

FIG. 2 is a schematic view illustrating the burglarproofing alarm for home use according to the first embodiment of the present invention, where a plurality of secondary bodies are coupled to the primary body of the burglarproofing alarm;

FIG. 3 is a top view of the burglarproofing alarm according to a second embodiment of the present invention, which is particularly for car use;

FIG. 4 is a rear view of the burglarproofing alarm for car use according to the second embodiment of the present invention;

FIG. 5 is a perspective view of a remote control used with the burglarproofing alarm for car use shown in FIG. 3 and FIG. 4;

FIG. 6 is a perspective view of the burglarproofing alarm according to a third embodiment of the present invention, which is particularly for car use and movable; and

FIG. 7 is display frame of a display window on the remote control showing different exceptions, respectively, according to the present invention.

### DETAILED DESCRIPTION OF THE INVENTION (PREFERRED EMBODIMENTS)

The burglarproofing alarm of this invention will be described in detail below with reference to the accompanying drawings.

### First Embodiment

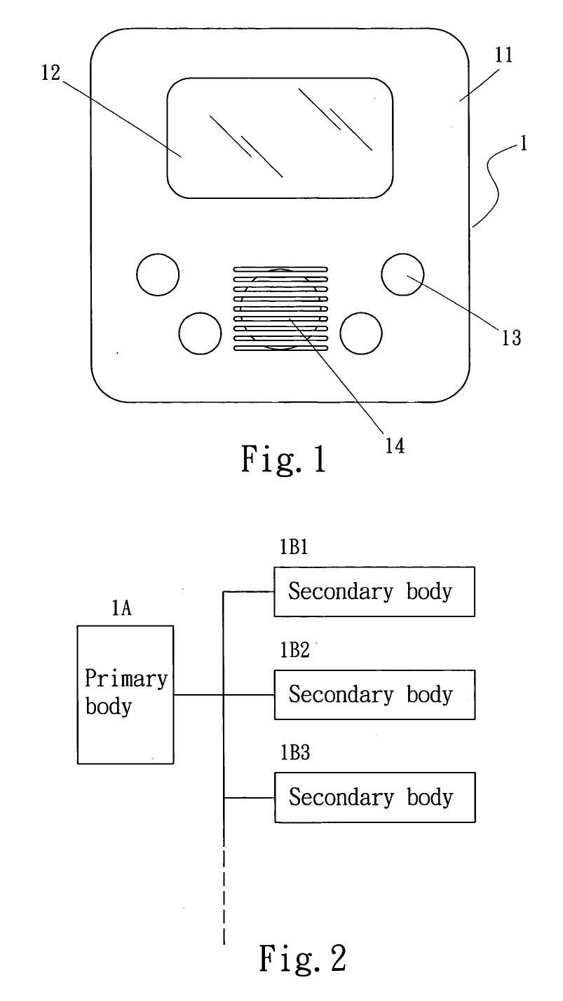

Referring to FIG. 1 and FIG. 2, a burglarproofing alarm for home use 1 (also termed as a home burglarproofing alarm in this specification) has a body case 11 shaped approximately like a square. On the body case 11, a display window 12 and buttons 13 (corresponding to different functions) are disposed. Inside the body case 11, a central control circuit, a sensor device and an alarm raising device are disposed. The sensor device comprises a pneumatic transducer and an active human body infrared ray transducer in the body case 11, the active human body infrared ray transducer has a sensing portion disposed outside the case body 11 for detection of the environment external to the body case 11.

The pneumatic transducer is used to detect air pressure deviation through a piezoelectric element therein. By means of an amplifying circuit, a digital signal associated with the air pressure deviation may be directly outputted. Such pneumatic transducer is suitable to be used in a close space, such as a car. Once any air pressure deviation takes place in the car, the pneumatic transducer issues a signal to the central control circuit.

Sensing precision wise, the current pneumatic transducer may detect a minimum pressure deviation up to 1 Pa.

Unlike the general infrared ray transducer, the active human body infrared ray transducer may actively detect any infrared ray emitted from a human body and then output a corresponding electric signal. Signals outputted from the pneumatic transducer and active human body infrared ray transducer are transmitted to the central control circuit through signal lines. In response to the signals, the central control circuit determines if an alarm should be issued based on analysis of the transmitted signals.

In addition, the sensor device in the burglarproofing alarm may also comprise an ultrasonic transducer. The ultrasonic transducer is similarly connected to the central control circuit so that a signal associated with detection of the ultrasonic transducer may be transmitted to the central control circuit.

It is to be noted that although the pneumatic transducer and active human body infrared ray transducer may jointly serve as a preferred sensor device, they may be independently used. For example, the user may select either of the pneumatic transducer and active human body infrared ray transducer as an activated transducer through a button 13 on the body case 11.

The primary body 1A of the burglarproofing alarm may work with a plurality of secondary bodies, e.g. 1B1, 1B2 and 1B3 in the example. The secondary bodies 1B1, 1B2 and 1B3 may be placed at a room or space other than where the primary body 1A is placed. These secondary bodies 1B1, 1B2 and 1B3 are coupled to the primary body 1A in a cabled or wireless manner so that each of the secondary bodies 1B1, 1B2 and 1B3 may transmit a signal corresponding to a detected exception to the primary body 1A. In the primary body 1A, the central control circuit determines if an alarm should be issued based on analysis of the inputted signal.

In each of the secondary bodies 1B1, 1B2 and 1B3, a sensor device and a signal transmission device are disposed. In the central control circuit, a reception device or circuit is disposed correspondingly.

For each of the secondary bodies 1B1, 1B2, 1B3, the sensor device may be selected based on the position of the secondary body. For example, if a secondary body is placed in a bedroom, the sensor device may comprise the pneumatic transducer and the active human body infrared ray transducer. In the case of being placed in a kitchen, the secondary body may comprise an infrared ray flame transducer so that a fire accident may be prevented from occurring. In addition, a magnetic transducer and an ultrasonic transducer may also be included in the secondary body.

The alarm may possibly issue an alarm signal improperly, for instance, when an increase or decrease of temperature causes a pressure variation in a close space. To avoid an improper alarm from being raised, an initial state, such as temperature when a user leaves a room or the car, of the pneumatic transducer may be kept in memory by the central control circuit. This data is taken as a reference so that future acquired data may be compared with the reference data. Based on the comparison result, the inputted signal to the central control circuit may be determined if it has reached a level beyond a reasonable range. In this manner, the alarm may be reasonably determined as to if it should be really activated.

Similarly, the active human body infrared ray transducer is also equipped with such analysis and determination mechanism. Specifically, the wavelength of the infrared ray emitted from the human body may be kept in memory. As such, the wavelength of the infrared ray emitted from other organisms may be avoided from mis-activating the alarm Based on this mechanism, reliability of the alarm of this invention is enhanced.

The alarm further comprises a high decibel buzzer/loudspeaker 14 so that the alarm may be used to intimidate the offender. In addition, an automatic dialing device/circuit may be provided for the alarm raising device so that the automatic dialing device may dial a predetermined telephone number to a telephone (a cellular phone is preferable) inform a user about the exception and the user may further say a warning through the loudspeaker of the primary body. Through the telephone, the user may monitor the sound acquired by the alarm and may then determine if an alarm should be issued by activating the buzzer through the telephone.

In addition, inside the body case of the burglarproofing alarm there is a sound recording device. When the burglarproofing alarm is activated, the sound recording device is activated simultaneously. Hence, sound around the burglarproofing alarm may be automatically recorded.

In this embodiment, the alarm may also consititute a visible doorbell system.

### Second Embodiment

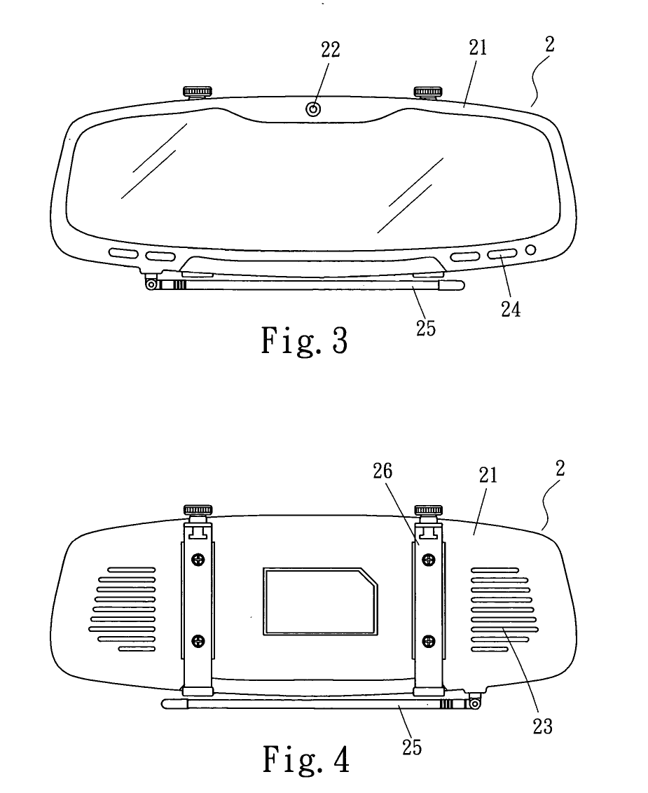

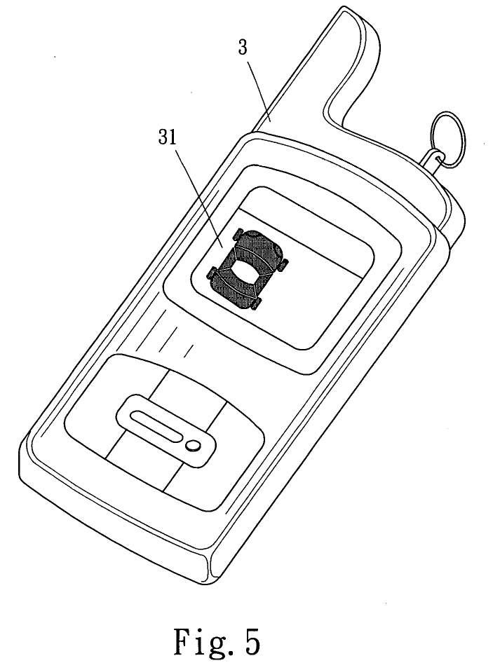

Referring to FIG. 3 and FIG. 4, a burglarproofing alarm 2 for car use (will also be termed as a car burglarproofing alarm in this specification) according to the present invention is schematically shown therein. The car burglarproofing alarm 2 also comprises a central control circuit, a sensor device and an alarm raising device. The sensor device comprises a pneumatic transducer disposed inside the body case 21 and an active human body infrared ray transducer 22 disposed on the body case 21.

In this embodiment, the sensor device and alarm raising device are both received in a rear-view mirror shaped body case 21. When an exception occurs, such as a car window being damaged, car door being opened, car trunk being opened, an air pressure deviation in the car is first detected by the pneumatic transducer and then the pneumatic transducer sends a signal to the central control circuit. Simultaneously, a human body infrared ray is detected by the active human body infrared transducer 22 and the active human body infrared transducer also sends an electric signal to the central control circuit. In response to the electric signals, the central control circuit analyzes and compares the acquired data to determine if an alarm should be issued. The alarm raising device may comprise a high decibel buzzer or loudspeaker 23.

In this embodiment, the user may select one of the above mentioned transducers through a button 24 on the body case 21. On the body case 21, an antenna device 25 and a fixation device 26 are also included.

In addition, the car using a burglarproofing alarm may preferably comprise a remote control 3. The remote control 3 may be used to activate/deactivate the burglarproofing alarm at a remote end. When the user is away from the car for a specific distance, he may send a signal to activate the alarm 2 through the remote control 3. When the user is near the car, he may send another signal to deactivate the alarm 2. Alternatively, the user may activate or deactivate the alarm manually through the remote control 3. As such, the alarm 2 may be automatically activated or deactivated without the need of a direct manual operation. When an exception occurs, the alarm 2 sends a signal to the remote control 3 requesting the vibration motor or buzzer in the remote control 3 to work. In this manner, the user may be notified about the exception that occurred.

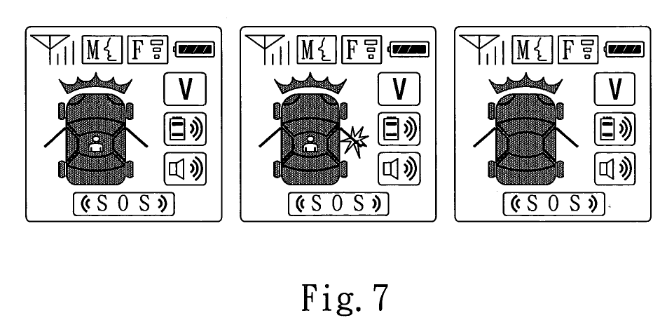

By means of the pneumatic and active human body infrared ray transducers 22, the central control circuit may determine which kind of exception has taken place. As examples, the exception may be a car window being damaged, car door being opened, car body being bumped or car being invaded. Preferably, the remote control 3 may also comprise a liquid crystal display (LCD) window 31 so that the exception may be displayed to the user through the LCD window 9. Referring to FIG. 7, display frames of the LCD window on the remote control according to the present invention are shown therein, in which different exceptions are respectively illustrated.

In addition, the car burglarproofing alarm 2 may also be used together with the home burglarproofing alarm 1. That is, the car burglarproofing alarm 2 may be used as a secondary body of the home burglarproofing alarm 1 (B1, B2, B3). In the case that the two alarms 1, 2 are within a distance where they may wirelessly communicate with each other, any exception detected by the alarm 2 may be managed by the alarm 1.

### Third Embodiment

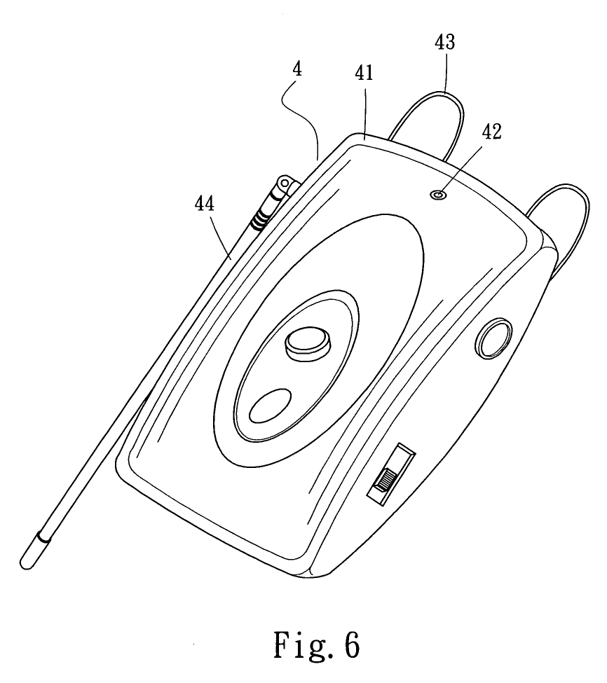

Referring to FIG. 6, the burglarproofing alarm according to a third embodiment of the present invention is schematically shown therein. The burglarproofing alarm 4 is a movable alarm and also comprises a central control circuit, a sensor device and an alarm raising device. The sensor device comprises a pneumatic transducer and an active human body infrared ray transducer 42 disposed in a body case and the alarm raising device has a sensing portion disposed outside a body case 41.

Unlike the car burglarproofing alarm 2, the central control circuit, sensor device and alarm raising device in this embodiment are all received in the separately disposed body case 41. In addition, the body case 41 has a gripper portion 43 through which the body case 31 may be fixed onto a sunshade board on the car. On the body case 41, an antenna device 44 is also disposed.

In conclusion, since the home and car burglarproofing alarms are provided with the pneumatic and active human body infrared ray transducers and the central control circuit having capability of analysis of the signals inputted thereinto, the possibility of issuance of an improper alarm is considerably reduced.

Many changes and modifications with respect to the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A pneumatic pressure burglarproofing alarm comprising a home pneumatic pressure burglarproofing alarm comprising a body case, a central control circuit, a sensor device and an alarm raising device disposed in said body case, said sensor device and alarm raising device being communicatively connected to said central control circuit and said home pneumatic pressure burglarproofing alarm being characterized in that said sensor device comprises a pneumatic transducer disposed in said body case and an active human body infrared ray transducer disposed on said body case.

2. The pneumatic pressure burglarproofing alarm according to claim 1, wherein said home pneumatic pressure burglarproofing alarm is further characterized in that said sensor device further comprises an ultrasonic transducer.

3. The pneumatic pressure burglarproofing alarm according to claim 1, wherein said home pneumatic pressure burglarproofing alarm is further characterized in that said pneumatic transducer comprises a piezoelectric element, which outputs an electric signal based on an air pressure deviation, and said active human body infrared ray transducer has a sensing portion for detecting an environment external to said pneumatic pressure burglarproofing alarm.

4. The pneumatic pressure burglarproofing alarm according to claim 1, wherein said home pneumatic pressure burglarproofing alarm is further characterized in that a primary body and a plurality of secondary bodies are comprised, said plurality of secondary bodies each having a sensor device and a transmitter device transmitting a signal to said central control circuit.

5. The pneumatic pressure burglarproofing alarm according to claim 4, wherein said home pneumatic pressure burglarproofing alarm is further characterized in that said sensor device of each of said secondary bodies comprises at least one of said pneumatic transducer, said active human body infrared ray transducer, an ultrasonic transducer, a magnetic transducer, an infrared ray transducer and an audio transducer.

6. The pneumatic pressure burglarproofing alarm according to claim 1, wherein said home pneumatic pressure burglarproofing alarm is further characterized in that a sound recording device is comprised, which is connected to and activated by said central control circuit.

7. The pneumatic pressure burglarproofing alarm according to claim 1, wherein said home pneumatic pressure burglarproofing alarm is further characterized in that only one of said transducers in said sensor device is selected to be activated.

8. The pneumatic pressure burglarproofing alarm according to claim 1, wherein said home pneumatic pressure burglarproofing alarm is further characterized in that an automatic dialing device is comprised, which automatically dials a predetermined telephone number when said alarm raising device is activated.

9. The pneumatic pressure burglarproofing alarm according to claim 1, further comprising a car pneumatic pressure burglarproofing alarm disposed in relation to a rear-view mirror and being characterized in that said car pneumatic pressure burglarproofing alarm comprises a central control circuit, a sensor device and an alarm raising device, said sensor device comprising a pneumatic transducer disposed in said body case and an active human body infrared ray transducer disposed on said body case.

10. The pneumatic pressure burglarproofing alarm according to, claim 9, wherein said car pneumatic pressure burglarproofing alarm is further characterized in that a remote control is comprised, which has at least one of a buzzer and a vibration motor disposed therein and at least one of said buzzer and vibration motor is activated concurrently when said car pneumatic pressure burglarproofing alarm is activated.

11. The pneumatic pressure burglarproofing alarm according to claim 9, wherein said car pneumatic pressure burglarproofing alarm is further characterized in that said remote control has a display window, which displays a human body position has been detected by said active human body infrared ray transducer under control of said central control circuit.

12. The pneumatic pressure burglarproofing alarm according to claim 1, further comprising a movable car pneumatic pressure burglarproofing alarm being characterized in that a central control circuit, a sensor device and an alarm raising device are comprised, said sensor device comprising a pneumatic transducer disposed in said body case and an active human body infrared ray transducer having a sensing portion disposed external to said body case, wherein said central control circuit, sensor device and alarm raising device of said movable car pneumatic pressure burglarproofing alarm are received in said body case separately disposed, said body case has a gripper portion attaching said body case to a sunshade board and an antenna device disposed on a proper position of said body case.
